(19) United States
(12) Patent Application Publication
(10) Pub. No.: US 2023/0008406 A1
(43) Pub. Date: Jan. 12, 2023

(54) File Storage Method and Apparatus, and Device and Readable Storage Medium

(71) Applicant: Inspur Electronic Information Industry Co., Ltd., Jinan, Shandong (CN)

(72) Inventors: Zhipeng Li, Jinan, Shandong (CN); Yonggang Hu, Jinan, Shandong (CN)

(21) Appl. No.: 17/782,527

(22) PCT Filed: Jul. 23, 2020
(86) PCT No.: PCT/CN2020/103691

§ 371 Date: Jun. 3, 2022

(30) Foreign Application Priority Data
Dec. 6, 2019 (CN) 201911244744.7

(51) Int. Cl. G06F 16/14; G06F 16/13; G06F 16/182; G06F 16/16

(52) U.S. Cl. CPC G06F 16/152; G06F 16/13; G06F 16/182; G06F 16/162

(57) ABSTRACT

A file storage method, apparatus, device and a readable storage medium. The method includes: performing striping processing on a target file to obtain multiple target objects, and calculating fingerprint information of each target object; using a first target object and logical information of the target file to form a logical header object, and storing the logical header object in a storage system; using the fingerprint information of each second target object to determine whether the second target object has been stored in the storage system; and if the second target object has not been stored in the storage system, determining the second target object as a third target object and storing same in the storage system. According to the method, logical information of each file can be preserved, and files of some users can be prevented from being modified or deleted after deduplication is performed in the storage system.

This application claims priority to Chinese patent application No. 201911244744.7, entitled “FILE STORAGE METHOD, APPARATUS, AND DEVICE AND READABLE STORAGE MEDIUM”, filed with the China National Intellectual Property Administration on Dec. 6, 2019, the disclosure of which is hereby incorporated by reference in its entirety.

### TECHNICAL FIELD

The present application relates to the field of object storage technologies, and in particular, to a file storage method, a file storage apparatus, a file storage device, and a computer-readable storage medium.

### BACKGROUND

A distributed object storage system performs distributed storage for unstructured data. At the current stage, a distributed object storage system needs to be used in more and more service scenarios. It becomes increasingly important to eliminate duplicate data in the storage system when uploading data to the storage system to improve the efficiency of storage usage.

In a current distributed object storage system, a logical header object is associated with metadata while carrying data content. A file fingerprint of an overall file is used as an identifier to participate in deduplication. The metadata includes a plurality of metadata attributes such as user rights and an object deletion time. After the storage system turns on deduplication, files with the same content have the same file fingerprint, and if a fingerprint of an overall file is used as an identifier of a logical header object of the file, only one of a plurality of logical header objects with the same file fingerprint is preserved during the deduplication. As a result, for logical header objects with different metadata attributes originally, files of different users or a plurality of files with different names correspond to the same logical header object. In turn, files with different metadata attributes become files with the same metadata, and metadata attributes such as rights are changed or overwritten, leading to modification or even deletion of files of some users after deduplication.

Therefore, how to resolve the problem that metadata attributes of users are changed after deduplication in existing distributed object storage systems is a technical problem to be solved by those skilled in the art.

### SUMMARY

In view of this, an objective of the present application is to provide a file storage method, a file storage apparatus, a file storage device, and a computer-readable storage medium, thereby resolving the problem that metadata attributes of users are changed after deduplication in existing distributed object storage systems.

To resolve the foregoing technical problems, the present application provides a file storage method, including:

performing striping processing on a target file to obtain a plurality of target objects, and calculating fingerprint information of each target object;

using a first target object and logical information of the target file to form a logical header object, and storing the logical header object in a storage system;

using the fingerprint information of each second target object to determine whether the second target object has been stored in the storage system; and

if the second target object has not been stored in the storage system, determining the second target object as a third target object and storing same in the storage system.

Optionally, the using a first target object and logical information of the target file to form a logical header object includes:

constructing slice information by using each fingerprint information and position information of each target object in the target file;

acquiring file information of the target file, and using the slice information and the file information to construct the logical information; and

splicing the logical information and the first target object to obtain the logical header object.

Optionally, the method further includes:

using a filename of the target file and corresponding bucket information to form a logical header name, and determining the logical header name as an object name of the logical header object.

Optionally, if the second target object has been stored in the storage system, the method includes:

determining an object corresponding to the second target object in the storage system as a fourth target object, and increasing a reference count of the fourth target object by 1.

Optionally, the determining the second target object as a third target object, and storing the third target object in the storage system includes:

encapsulating the second target object and second target information corresponding to the second target object to obtain the third target object, where the second target information includes the fingerprint information or a reference count of the second target object; and

storing the third target object in the storage system.

Optionally, the using the fingerprint information of each second target object to determine whether the second target object has been stored in the storage system includes:

acquiring index information corresponding to the storage system; and

comparing the fingerprint information of each second target object with stored fingerprint information in the index information, and determining whether the fingerprint information matches the stored fingerprint information.

Optionally, the calculating fingerprint information of each target object includes:

calculating the fingerprint information corresponding to each target object by using a SHA1 algorithm or a SHA256 algorithm.

The present application further provides a file storage apparatus, including:

a fingerprint information calculation module, configured to perform striping processing on a target file to obtain a plurality of target objects, and calculate fingerprint information of each target object;

a logical header object construction module, configured to use a first target object and logical information of the target file to form a logical header object, and store the logical header object in a storage system;

a determination module, configured to use the fingerprint information of each second target object to determine whether the second target object has been stored in the storage system; and

a storage module, configured to if the second target object has not been stored in the storage system, determine the second target object as a third target object, and store the third target object in the storage system.

The present application further provides a file storage device, including: a memory and a processor, where the memory is configured to store a computer program; and

the processor is configured to execute the computer program to implement the foregoing file storage method. The present application further provides a computer-readable storage medium, configured to store a computer program. The computer program implements, when being executed by the processor, the foregoing file storage method.

In the file storage method provided in the embodiments, striping processing is performed on a target file to obtain a plurality of target objects, and fingerprint information of each target object is calculated; a first target object and logical information of the target file are used to form a logical header object, and the logical header object is stored in a storage system; the fingerprint information of each second target object is used to determine whether the second target object has been stored in the storage system; and if the second target object has not been stored in the storage system, the second target object is determined as a third target object and is stored in the storage system.

As can be seen, in the method, deduplication processing is not performed on a logical header object with logical information, logical header objects of all files are stored in a storage system, and in addition fingerprint information is used to perform deduplication processing on a second target object. That is, after it is determined that the second target object has not been stored in the storage system, the second target object is stored in the storage system. Because the logical header objects are all stored in the storage system and do not participant in deduplication processing of the storage system, logical information of the files can be preserved, so that logical information corresponding to the same file stored by different users are kept from being deleted, to prevent files of some users from being modified or deleted after the deduplication of the storage system, thereby resolving the problem that metadata attributes of users are changed after deduplication in existing distributed object storage systems.

In addition, the present application further provides a file storage apparatus, a file storage device, and a computer-readable storage medium, which also have the foregoing beneficial effects.

### BRIEF DESCRIPTION OF THE DRAWINGS

To describe the technical solutions in the embodiments of the present application or the prior art more clearly, the following briefly introduces the accompanying drawings required for describing the embodiments or the prior art. Apparently, the accompanying drawings in the following description show merely embodiments of the present application, and a person of ordinary skill in the art may still derive other drawings from the provided accompanying drawings without creative efforts.

FIG. 1 is a flowchart of a file storage method according to an embodiment of the present application;

FIG. 2 is a flowchart of constructing a logical header object according to an embodiment of the present application;

FIG. 3 is a flowchart of storing a second target object according to an embodiment of the present application;

FIG. 4 is a flowchart of a process of determining the presence of a second target object according to an embodiment of the present application;

FIG. 5 is a schematic structural diagram of a file storage apparatus according to an embodiment of the present application; and

FIG. 6 is a schematic structural diagram of a file storage device according to an embodiment of the present application;

### DETAILED DESCRIPTION

To make the objectives, technical solutions, and advantages of the embodiments of the present application clearer, the following clearly and completely describes the technical solutions in embodiments of the present application with reference to the accompanying drawings in embodiments of the present application. Apparently, the described embodiments are some rather than all of the embodiments of the present application. All other embodiments obtained by persons of ordinary skill in the art based on the embodiments of the present application without creative efforts shall fall within the protection scope of the present application.

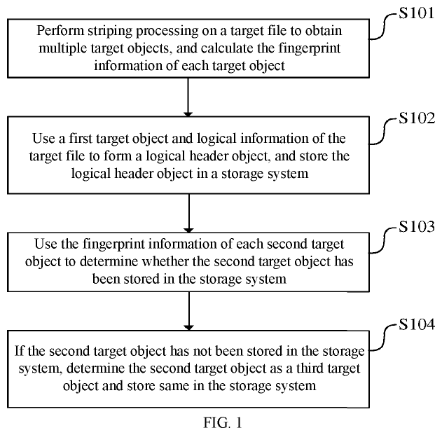

FIG. 1 is a flowchart of a file storage method according to an embodiment of the present application. The method includes the following steps.

S101: Perform striping processing on a target file to obtain a plurality of target objects, and calculate fingerprint information of each target object.

In an object storage system, a server performs a storage operation on a file. Therefore, the server may perform the file storage method provided in the present application. A target file is a file that needs to be stored in the storage system. The specific content and size of the file are not limited in this embodiment. A plurality of target objects may be obtained by performing striping processing on the target file. In the embodiments of the present application, the target objects have the same size. A quantity of the target objects is related to a specific size of the target file. Specifically, striping processing may be performed on a target file as soon as the target file is detected. Alternatively, when an upload request is detected, striping processing may be performed on a target file designated by the upload request. The upload request and the target file may be sent by a client. After a plurality of target objects are obtained, fingerprint information of each target object is calculated. The fingerprint information may be used for determining whether two objects are the same. When two objects have the same fingerprint information, it indicates that the two objects have identical content. Optionally, in the embodiments of the present application, the fingerprint information corresponding to each target object is calculated by using a SHA1 algorithm or a SHA256 algorithm.

S102: Use a first target object and logical information of the target file to form a logical header object, and store the logical header object in a storage system.

In the embodiments, the first target object is the first target object obtained by dividing the target file, that is, a beginning target object of the target file. The logical information is used for recording a relationship between each target object and the target file, for example, a position relationship of each target object in the target file. The logical information may further record some other information, for example, file information of the target file. The file information may include user right information, expiry delete information, and the like. The first target object and the logical information of the target file are used to form the logical header object.

In the prior art, all target objects obtained after striping processing of a target file need to participate in deduplication. That is, it is determined whether each target object has been stored in a storage system. If a target object has been stored in the storage system, the target object is not stored in the storage system. If a target object has not been stored in the storage system, the target object is stored in the storage system. Therefore, a logical header object formed by a first target object and logical information also need to participate in deduplication. When the first target object has been stored in the storage system, the logical header object corresponding to the first target object cannot be stored in the storage system, and the logical information in the logical header object is also discarded. As a result, a plurality of files may correspond to one logical header object. Because users have different logical information, files of some users may be modified or even deleted. For example, when an unstored logical header object of a user A has a relatively long expiry delete time and a logical header object of a user B corresponding to the user A in the storage system has a relatively short expiry delete time, a file of the user A is deleted in advance.

To resolve this problem, after the first target object and the logical information of the target file are used to form the logical header object, the logical header object is stored in the storage system, and deduplication processing is not performed on the logical header object. That is, it is not determined whether the first target object has been stored in the storage system, but instead logical header objects of all target files are stored in the storage system. When the logical header object is stored in the storage system, the logical header object may be stored in a target bucket designated in the upload request corresponding to the target file.

Further, after the logical header object is formed and before the logical header object is stored in the storage system, a filename of the target file and bucket information corresponding to the target file may be used to form a logical header name, and the logical header name is determined as an object name of the logical header object. The bucket information corresponding to the target file may be a bucket name or may be a bucket id. The bucket information may be located in the upload request corresponding to the target file or the corresponding bucket information may be acquired at the same time when the target file is acquired. Files with the same name cannot exist in one bucket. Therefore, when a filename and bucket information are used to name a logical header object, it may be convenient to determine different logical header objects corresponding to the same file, thereby accelerating the determination of files.

S103: Use the fingerprint information of each second target object to determine whether the second target object has been stored in the storage system.

The second target objects are target objects other than the first target object in all target objects. The fingerprint information of each second target object is used to determine whether the second target object has been stored in the storage system. For example, objects in the storage system may be traversed to acquire fingerprint information corresponding to the objects, and the fingerprint information and fingerprint information of a second target object are used to determine whether the second target object has been stored in the storage system.

S104: If the second target object has not been stored in the storage system, determine the second target object as a third target object and store same in the storage system.

The third target object is a version of the second target object being stored in the storage system, and includes both the second target object and object information corresponding to the second target object. The object information may be fingerprint information of the second target object or may further include information such as a sequence number of the second target object. Specific content of the object information is not limited in this embodiment. When it is determined that the second target object has not been stored in the storage system, the second target object is determined as a third target object. That is, the second target object is encapsulated as a third target object and is stored in the storage system.

Further, if the second target object has been stored in the storage system, an object corresponding to the second target object in the storage system is determined as a fourth target object, and a reference count of the fourth target object is increased by 1. The reference count of the fourth target object may be located in object information of the fourth target object or may be located in index information corresponding to the entire storage system. After the reference count of the fourth target object is modified, the second target object may be deleted, and determination is performed on a next second target object.

During the application of the file storage method provided in the embodiments of the present application, deduplication processing is not performed on a logical header object with logical information, logical header objects of all files are stored in a storage system, and in addition fingerprint information is used to perform deduplication processing on a second target object. That is, after it is determined that the second target object has not been stored in the storage system, the second target object is stored in the storage system. Because the logical header objects are all stored in the storage system and do not participant in deduplication processing of the storage system, logical information of the files can be preserved, so that logical information corresponding to the same file stored by different users are kept from being deleted, to prevent files of some users from being modified or deleted after the deduplication of the storage system, thereby resolving the problem that metadata attributes of users are changed after deduplication in existing distributed object storage systems.

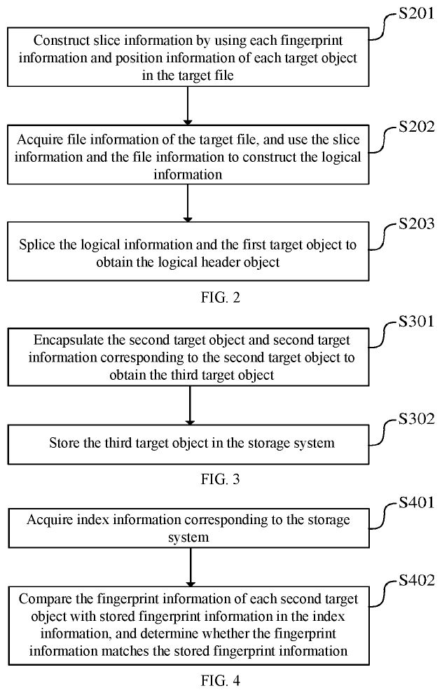

Based on the foregoing embodiments of the present application, a specific process of constructing a logical header object is described in the embodiments of the present application. That is, step S102 is described in detail. FIG. 2 is a flowchart of constructing a logical header object according to an embodiment of the present application. The construction includes the following steps.

S201: Construct slice information by using each fingerprint information and position information of each target object in the target file.

The position information of each target object in the target file is used for recording a position of the target object in the target file. Specific content of the position information varies according to different target objects. For example, position information corresponding to the first target object may be 1, representing that a position of the first target object in the target file is the first position. The slice information is constructed by using each fingerprint information and position information of each target object in the target file. For example, the fingerprint information may be arranged in ascending order, and the position information of the target objects is arranged according to the arrangement sequence after arrangement. The arranged fingerprint information and position information are combined into slice information. Alternatively, corresponding fingerprint information is arranged according to position information of the target objects. For example, fingerprint information with a position of 1 is placed at the first position, fingerprint information with a position of 2 is placed next to the first position, and fingerprint information with a position of 3 is placed next to the second position. The rest is deduced by analogy. Finally, an arranged fingerprint information sequence is determined as the slice information.

S202: Acquire file information of the target file, and use the slice information and the file information to construct the logical information.

The file information of the target file may include an OID rule, expiry delete information, an ACL, owner information, user right information, and the like. The file information may further include other information. Specific content of the file information is not limited in this embodiment. The slice information and the file information are used to construct the logical information. Specifically, the slice information and the file information may be processed according to a preset construction rule to obtain logical information.

S203: Splice the logical information and the first target object to obtain the logical header object. Specifically, splicing may be performed according to a rule that the logical information comes before the first target object to obtain the logical header object.

Based on the foregoing embodiments of the present application, a specific process of storing a second target object is described in the embodiments of the present application. That is, step S104 is described in detail. FIG. 3 is a flowchart of storing a second target object according to an embodiment of the present application. The storage includes the following steps.

S301: Encapsulate the second target object and second target information corresponding to the second target object to obtain the third target object.

It needs to be noted that the second target information may be fingerprint information corresponding to the second target object or may be a reference count corresponding to the second target object or may be a combination of the fingerprint information and the reference count. The second target information and the second target object are encapsulated to obtain the third target object, to facilitate the use of the second target information to locate the second target object in the storage system.

S302: Store the third target object in the storage system.

Specifically, the third target object may be stored in a target bucket designated in upload information corresponding to the target file.

Based on the foregoing embodiments of the present application, a process of determining whether the second target object has been stored in the storage system is described in the embodiments of the present application. FIG. 4 is a flowchart of a process of determining the presence of a second target object according to an embodiment of the present application. The process includes the following steps.

S401: Acquire index information corresponding to the storage system.

The index information is used for recording information such as fingerprint information of stored objects and a reference count in the storage system, and may further record sequence number information of the stored objects. During the determination of whether the stored objects have been stored in the storage system, index information may be acquired, and the index information is read to facilitate the acquisition of the stored fingerprint information or reference count.

S402: Compare the fingerprint information of each second target object with stored fingerprint information in the index information, and determine whether the fingerprint information matches the stored fingerprint information.

The fingerprint information of each second target object is compared with stored fingerprint information in the index information, and it is determined whether the fingerprint information matches. When fingerprint information of a second target object is the same as, that is, matches stored fingerprint information in the index information, it indicates that the second target object has been stored in the storage system. If fingerprint information of a second target object matches none of the stored fingerprint information in the index information, it indicates that the second target object is not stored in the storage system.

The file storage apparatus provided in the embodiments of the present application is described below. Corresponding reference may be made between the file storage apparatus described below and the file storage method described above.

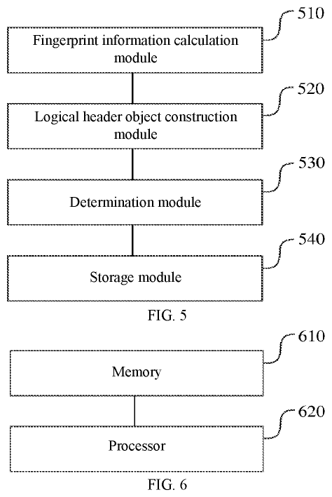

FIG. 5 is a schematic structural diagram of a file storage apparatus according to an embodiment of the present application. The apparatus includes:

a fingerprint information calculation module 510, configured to perform striping processing on a target file to obtain a plurality of target objects, and calculate fingerprint information of each target object;

a logical header object construction module 520, configured to use a first target object and logical information of the target file to form a logical header object, and store the logical header object in a storage system;

a determination module 530, configured to use the fingerprint information of each second target object to determine whether the second target object has been stored in the storage system; and

a storage module 540, configured to if the second target object has not been stored in the storage system, determine the second target object as a third target object, and store the third target object in the storage system.

Optionally, the logical header object construction module 520 includes:

a slice information acquisition unit, configured to construct slice information by using each fingerprint information and position information of each target object in the target file;

a logical information construction unit, configured to acquire file information of the target file, and use the slice information and the file information to construct the logical information; and

a splicing unit, configured to splice the logical information and the first target object to obtain the logical header object.

Optionally, the apparatus further includes:

a logical header name determination module, configured to use a filename of the target file and corresponding bucket information to form a logical header name, and determine the logical header name as an object name of the logical header object.

Optionally, the apparatus includes:

a reference count modification module, configured to determine an object corresponding to the second target object in the storage system as a fourth target object, and increase a reference count of the fourth target object by 1.

Optionally, the storage module 540 includes:

an encapsulation unit, configured to encapsulate the second target object and second target information corresponding to the second target object to obtain the third target object, where the second target information includes the fingerprint information or a reference count of the second target object; and

a storage unit, configured to store the third target object in the storage system.

Optionally, the determination module 530 includes:

an index information acquisition unit, configured to acquire index information corresponding to the storage system; and

a matching determination unit, configured to compare the fingerprint information of each second target object with stored fingerprint information in the index information, and determine whether the fingerprint information matches the stored fingerprint information.

Optionally, the fingerprint information calculation module 510 includes:

a calculation unit, configured to calculate the fingerprint information corresponding to each target object by using a SHA1 algorithm or a SHA256 algorithm.

The file storage device provided in the embodiments of the present application is described below. Corresponding reference may be made between the file storage device described below and the file storage method described above.

FIG. 6 is a schematic structural diagram of a file storage device according to an embodiment of the present application. The file storage device includes a memory and a processor.

The memory 610 is configured to store a computer program.

The processor 620 is configured to execute the computer program to implement the foregoing file storage method.

The computer-readable storage medium provided in the embodiments of the present application is described below. Corresponding reference may be made between the computer-readable storage medium described below and the file storage method described above.

The present application further provides a computer-readable storage medium. The computer-readable storage medium stores a computer program. The computer program implements, when being executed by the processor, the steps in the foregoing file storage method.

The foregoing storage medium includes various media that can store program code, such as a Universal Serial Bus (USB) flash drive, a removable hard disk, a read-only memory (ROM), a random access memory (RAM), a magnetic disk or an optical disc.

All embodiments are described in this specification by using the progressive method. Each embodiment describes only the difference from other embodiments. For the same or similar parts among all embodiments, reference may be made to the relevant parts. For the apparatus disclosed in the embodiments, because the apparatus corresponds to the method disclosed in the embodiments, the description is relatively simple. For related parts, reference may be made to the description of the method part.

A person skilled in the art may further be aware that, in combination with the examples described in the embodiments disclosed in this specification, units and algorithm steps may be implemented by electronic hardware, computer software, or a combination thereof. To clearly describe the interchangeability between the hardware and the software, the foregoing has generally described compositions and steps of each example according to functions. Whether the functions are performed by hardware or software depends on particular applications and design constraint conditions of the technical solutions. A person skilled in the art may use different methods to implement the described functions for each particular application, but it should not be considered that the implementation goes beyond the scope of the present application.

Steps of methods or algorithms described in the embodiments disclosed in this specification may be directly implemented by hardware, a software module executed by a processor, or a combination thereof. The software module may reside in a RAM, a memory, a ROM, an electrically programmable ROM, an electrically erasable programmable ROM, a register, a hard disk, a removable disk, a CD-ROM, or any other form of storage medium known in the art.

Finally, it should be noted that the relational terms herein such as first and second are used only to differentiate an entity or operation from another entity or operation, and do not require or imply any actual relationship or sequence between these entities or operations. Moreover, the terms “include”, “comprise”, or any variation thereof are intended to cover a non-exclusive inclusion. Therefore, in the context of a process, method, object, or device that includes a series of elements, the process, method, object, or device not only includes such elements, but also includes other elements not specified expressly, or may include inherent elements of the process, method, object, or device.

The file storage method, the file storage apparatus, the file storage device, and the computer-readable storage medium provided in the present application are described above in detail. Although the principle and embodiments of the present application are described by using specific examples in this specification, descriptions of the embodiments are merely intended to help understand the methods and core idea of the present application. In addition, for a person of ordinary skill in the art, according to the idea of the present application, changes may be made to the specific implementation and the scope of application. In summary, the content of this specification should not be construed as a limitation to the present application.

1. A file storage method, comprising:
performing striping processing on a target file to obtain a plurality of target objects, and calculating fingerprint information of each target object;
using a first target object and logical information of the target file to form a logical header object, and storing the logical header object in a storage system;
using the fingerprint information of each second target object to determine whether the second target object has been stored in the storage system; and
if the second target object has not been stored in the storage system, determining the second target object as a third target object and storing same in the storage system.

2. The file storage method according to claim 1, wherein the using a first target object and logical information of the target file to form a logical header object comprises:
constructing slice information by using each fingerprint information and position information of each target object in the target file;
acquiring file information of the target file, and using the slice information and the file information to construct the logical information; and
splicing the logical information and the first target object to obtain the logical header object.

3. The file storage method according to claim 1, further comprising:
using a filename of the target file and corresponding bucket information to form a logical header name, and determining the logical header name as an object name of the logical header object.

4. The file storage method according to claim 1, wherein if the second target object has been stored in the storage system, the method comprises:
determining an object corresponding to the second target object in the storage system as a fourth target object, and increasing a reference count of the fourth target object by 1.

5. The file storage method according to claim 1, wherein the determining the second target object as a third target object and storing same in the storage system comprises:
encapsulating the second target object and second target information corresponding to the second target object to obtain the third target object, wherein the second target information comprises the fingerprint information or a reference count of the second target object; and
storing the third target object in the storage system.

6. The file storage method according to claim 1, wherein the using the fingerprint information of each second target object to determine whether the second target object has been stored in the storage system comprises:
acquiring index information corresponding to the storage system; and
comparing the fingerprint information of each second target object with stored fingerprint information in the index information, and determining whether the fingerprint information matches the stored fingerprint information.

7. The file storage method according to claim 1, wherein the calculating fingerprint information of each target object comprises:
calculating the fingerprint information corresponding to each target object by using a SHA1 algorithm or a SHA256 algorithm.

8. (canceled)

9. A file storage device, comprising: a memory and a processor, wherein
the memory is configured to store a computer program; and
the processor is configured to execute the computer program to implement the file storage method, comprising:
performing striping processing on a target file to obtain a plurality of target objects, and calculating fingerprint information of each target object;
using a first target object and logical information of the target file to form a logical header object, and storing the logical header object in a storage system;
using the fingerprint information of each second target object to determine whether the second target object has been stored in the storage system; and
if the second target object has not been stored in the storage system, determining the second target object as a third target object and storing same in the storage system.

10. A computer-readable storage medium, wherein the readable storage medium stores a computer program, and the computer program implements, when being executed by the processor, the file storage method, comprising:
performing striping processing on a target file to obtain a plurality of target objects, and calculating fingerprint information of each target object;
using a first target object and logical information of the target file to form a logical header object, and storing the logical header object in a storage system;
using the fingerprint information of each second target object to determine whether the second target object has been stored in the storage system; and
if the second target object has not been stored in the storage system, determining the second target object as a third target object and storing same in the storage system.

11. The file storage device according to claim 9, wherein the using a first target object and logical information of the target file to form a logical header object comprises:
constructing slice information by using each fingerprint information and position information of each target object in the target file;
acquiring file information of the target file, and using the slice information and the file information to construct the logical information; and
splicing the logical information and the first target object to obtain the logical header object.

12. The file storage device according to claim 9, further comprising:
using a filename of the target file and corresponding bucket information to form a logical header name, and determining the logical header name as an object name of the logical header object.

13. The file storage device according to claim 9, wherein if the second target object has been stored in the storage system, the method comprises:
determining an object corresponding to the second target object in the storage system as a fourth target object, and increasing a reference count of the fourth target object by 1.

14. The file storage device according to claim 9, wherein the determining the second target object as a third target object and storing same in the storage system comprises:
encapsulating the second target object and second target information corresponding to the second target object to obtain the third target object, wherein the second target information comprises the fingerprint information or a reference count of the second target object; and
storing the third target object in the storage system.

15. The file storage device according to claim 9, wherein the using the fingerprint information of each second target object to determine whether the second target object has been stored in the storage system comprises:
acquiring index information corresponding to the storage system; and
comparing the fingerprint information of each second target object with stored fingerprint information in the index information, and determining whether the fingerprint information matches the stored fingerprint information.

16. The file storage device according to claim 9, wherein the calculating fingerprint information of each target object comprises:
calculating the fingerprint information corresponding to each target object by using a SHA1 algorithm or a SHA256 algorithm.

17. The computer-readable storage medium according to claim 10, wherein the using a first target object and logical information of the target file to form a logical header object comprises:
constructing slice information by using each fingerprint information and position information of each target object in the target file;
acquiring file information of the target file, and using the slice information and the file information to construct the logical information; and
splicing the logical information and the first target object to obtain the logical header object.

18. The computer-readable storage medium according to claim 10, further comprising:
using a filename of the target file and corresponding bucket information to form a logical header name, and determining the logical header name as an object name of the logical header object.

19. The computer-readable storage medium according to claim 10, wherein if the second target object has been stored in the storage system, the method comprises:
determining an object corresponding to the second target object in the storage system as a fourth target object, and increasing a reference count of the fourth target object by 1.

20. The computer-readable storage medium according to claim 10, wherein the determining the second target object as a third target object and storing same in the storage system comprises:
encapsulating the second target object and second target information corresponding to the second target object to obtain the third target object, wherein the second target information comprises the fingerprint information or a reference count of the second target object; and
storing the third target object in the storage system.

21. The computer-readable storage medium according to claim 10, wherein the using the fingerprint information of each second target object to determine whether the second target object has been stored in the storage system comprises:
acquiring index information corresponding to the storage system; and
comparing the fingerprint information of each second target object with stored fingerprint information in the index information, and determining whether the fingerprint information matches the stored fingerprint information.
